(19) United States
(12) Patent Application Publication
(10) Pub. No.: US 2015/0363793 A1
(43) Pub. Date: Dec. 17, 2015

(54) SYSTEMS AND METHODS FOR COLLECTING AND USING RETAIL ITEM INSPECTION DATA

(71) Applicant: Google Inc., Mountain view, CA (US)

(72) Inventor: Hoi Chuen Lam, Mountain View, CA (US)

(73) Assignee: Google Inc., Mountain view, CA (US)

(21) Appl. No.: 14/157,946

(22) Filed: Jan. 17, 2014

(51) Int. Cl. G06Q 30/02

(52) U.S. Cl. CPC G06Q 30/0201; G06Q 30/0246; G06Q 30/0273

(57) ABSTRACT

Systems and methods for collecting and using retail item inspection data are provided. Consumer inspection data for a retail item (e.g., a product or service) are collected at an offline location and received at a computing system. The consumer inspection data indicate a number of consumer inspections of the retail item at the offline location. The computing system uses the consumer inspection data to generate an inspection-related metric for the retail item. The inspection-related metric is a function of the number of consumer inspections of the retail item at the offline location. The inspection-related metric can be exposed to content a content provider of online content (e.g., to help determine an offline impact of online content) and/or a retailer or merchant at the offline location (e.g., to help in pricing the retail item or to diagnose issues in poor sales performance).

### BACKGROUND

The Internet provides access to a wide variety of content. A content distribution system may allow a third-party content provider to automatically provide its content in conjunction with that of a first-party resource. For example, the content distribution system may allow an advertiser to bid on an opportunity to present an advertisement on a particular webpage. Content selection and distribution can be automated by a programmatic Internet advertising system.

Some programmatic Internet advertising systems measure the effectiveness of third-party content using various performance metrics. For example, the effectiveness of third-party content can be measured in terms of a number of conversions associated therewith. Conversions are generally limited to online actions such as clicking on a third-party content item, visiting a webpage associated with the third-party content, or making an online purchase of an item associated with the third-party content. Offline actions are more difficult to measure and associate with the third-party content.

In a physical retail store, consumers often inspect a retail item before purchasing it. For example, in an apparel store, consumers can try on apparel in a fitting room. Retailers typically do not measure or collect consumer inspection data and generally rely sales data as the only offline performance metric. It is difficult and challenging to measure an offline effectiveness of online content.

### SUMMARY

One implementation of the present disclosure is a computer-implemented method for measuring an offline impact of online content. The method includes delivering, from a computing system to one or more user devices, online content associated with a retail item. The method further includes receiving, at the computing system, consumer inspection data for the retail item. The consumer inspection data include an indication of a number of consumer inspections of the retail item at an offline location. The method further includes using the consumer inspection data to generate, by the computing system, an inspection-related metric for the online content. The inspection-related metric is a function of the number of consumer inspections of the retail item at the offline location. The method further includes exposing the inspection-related metric to a content provider associated with the online content.

In some implementations, the consumer inspection data measure a consumer interest in the retail item at the offline location not necessarily reflected in consumer purchase data for the retail item.

In some implementations, the method further includes associating the online content with the inspection-related metric for the retail item, using the inspection-related metric to determine a pricing value for the online content, and determining a target bid for the online content based on the pricing value for the online content.

In some implementations, the method further includes using the inspection-related metric to determine a pricing value for the online content and, in a programmatic auction, submitting a bid on an opportunity to present the online content. The bid may be a function of the pricing value for the online content.

In some implementations, the inspection-related metric is an effective cost of the consumer inspections of the retail item at the offline location. The method may further include determining a ranking for the online content based on the effective cost of the consumer inspections.

In some implementations, the method further includes receiving consumer purchase data for the retail item. The consumer purchase data may include an indication of a number of consumer purchases of the retail item at the offline location. In some implementations, the method further includes determining a difference between the number of consumer inspections of the retail item at the offline location and the number of consumer purchases of the retail item at the offline location and using the difference between the number of consumer inspections and the number of consumer purchases to generate a performance metric for the retail item.

In some implementations, the online content associated with the retail item includes at least one of advertising content associated with the retail item, a website related to the retail item, or an online review of the retail item.

In some implementations, the retail item is at least one of a consumer product or a consumer service available for purchase at the offline location. In some implementations, a consumer inspection of the retail item at the offline location includes at least one of trying on an item of apparel at the offline location, viewing the retail item in a physical store at the offline location, or using the retail item.

Another implementation of the present disclosure is a computer-implemented method for using consumer inspection data to price retail items. The method includes receiving, at a computing system, consumer inspection data for a first retail item and a second retail item. The consumer inspection data includes an indication of a number of consumer inspections of the first retail item at an offline location and an indication of a number of consumer inspections of the second retail item at the offline location. The method further includes using the consumer inspection data to generate, by the computing system, a first inspection-related metric for the first retail item and a second inspection-related metric for the second retail item. The first inspection-related metric is a function of the number of consumer inspections of the first retail item at the offline location and the second inspection-related metric is a function of the number of consumer inspections of the second retail item at the offline location. The method further includes calculating, by the computing system, a difference between the first inspection-related metric and the second inspection-related metric and, in response to the difference between the first inspection-related metric and the second inspection-related metric exceeding a threshold value, determining, by the computing system, a pricing value for the first retail item and the second retail item such that the pricing value for the first retail item exceeds the pricing value for the second retail item.

In some implementations, the consumer inspection data measure a consumer interest in the first retail item and the second retail item at the offline location not necessarily reflected in consumer purchase data for the retail items.

In some implementations, the method further includes, in response to the difference between the first inspection-related metric and the second-related metric not exceeding the threshold value, determining, by the computing system, a pricing value for the first retail item and the second retail item such that the pricing value for the first retail item is equal to the pricing value for the second retail item.

In some implementations, the method further includes, prior to receiving the consumer inspection data, receiving consumer purchase data for the first retail item and the second retail item. The consumer purchase data may include an indication of a number of consumer purchases of the first retail item at the offline location and an indication of a number of consumer purchases of the second retail item at the offline location. In some implementations, the method further includes determining whether a difference between the number of consumer purchases of the first retail item and the number of consumer purchases of the second retail item exceeds a threshold number of purchases. Receiving the consumer inspection data for the first retail item and the second retail item may be performed in response to a determination that the difference between the number of consumer purchases of the first retail item and the number of consumer purchases of the second retail item does not exceed the threshold number of purchases.

In some implementations, the method further includes, in response to a determination that the number of consumer purchases of the first retail item exceeds the number of consumer purchases of the second retail item by at least the threshold number of purchases, determining, by the computing system, a pricing value for the first retail item and the second retail item such that the pricing value for the first retail item exceeds the pricing value for the second retail item.

Another implementation of the present disclosure is a computer-implemented method for diagnosing sales performance issues with a retail item. The method includes receiving, at a computing system, consumer inspection data for a retail item. The consumer inspection data includes an indication of a number of consumer inspections of the retail item at a first offline location. The method further includes comparing the number of consumer inspections of the retail item at the first offline location with a threshold number of inspections. In response to a determination that the number of consumer inspections of the retail item at the first offline location exceeds the threshold number of inspections, the method includes attributing a poor sales performance to an item-specific issue. In response to a determination that the number of consumer inspections of the retail item at the first offline location does not exceed the threshold number of inspections, the method includes attributing the poor sales performance to at least one of a promotional issue or a location-specific issue.

In some implementations, the method further includes, in response to a determination that the number of consumer inspections of the retail item at the first offline location does not exceed the threshold number of inspections, receiving consumer inspection data indicating a number of consumer inspections of the retail item at a second offline location, comparing a difference between the number of consumer inspections of the retail item at the second offline location and the number of consumer inspections of the retail item at the first offline location with a threshold difference value, and attributing the poor sales performance to either a promotional issue or a location specific issue based on a result of the comparison.

In some implementations, the method further includes attributing the poor sales performance to a promotional issue in response to a determination that the difference between the number of consumer inspections of the retail item at the second offline location and the number of consumer inspections of the retail item at the first offline location does not exceed the threshold difference value.

In some implementations, the method further includes attributing the poor sales performance to a location-specific issue in response to a determination that the difference between the number of consumer inspections of the retail item at the second offline location and the number of consumer inspections of the retail item at the first offline location exceeds the threshold difference value.

In some implementations, the method further includes, in response to a determination that the number of consumer inspections of the retail item at the first offline location exceeds the threshold number of inspections, receiving consumer purchase data indicating a number of consumer purchases of the retail item at the first offline location, comparing a difference between the number of consumer inspections of the retail item at the first offline location and the number of consumer purchases of the retail item at the first offline location with a threshold difference value, and determining whether an item-specific issue is causing a poor sales performance based on a result of the comparison.

In some implementations, the method further includes attributing the poor sales performance to an item-specific issue in response to a determination that the number of consumer inspections of the retail item at the first offline location and the number of consumer purchases of the retail item at the first offline location exceeds the threshold difference value

The foregoing is a summary and thus by necessity contains simplifications, generalizations, and omissions of detail. Consequently, those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is block diagram of a computing system including an offline location at which consumer inspection data for a retail item is collected and a data analysis system which receives and analyzes the consumer inspection data, according to a described implementation.

FIG. 2 is a block diagram illustrating the data analysis system of FIG. 1 in greater detail, according to a described implementation.

FIG. 3 is a flowchart of a process for measuring an offline impact of online content using consumer inspection data collected at the offline location of FIG. 1, according to a described implementation.

FIG. 4 is a flowchart of a process for determining a pricing value for a retail item using consumer inspection data, according to a described implementation.

FIG. 5 is a flowchart of a process for diagnosing issues in the sales performance of a retail item using consumer inspection data, according to a described implementation.

### DETAILED DESCRIPTION

Referring generally to the FIGURES, systems and methods for collecting and using retail item inspection data are shown according to a described implementation. The systems and methods described herein may be used to measure a number of consumer inspections of a retail item (e.g., a consumer product, a consumer service, etc.) at an offline location such as a physical retail store. For example, inspecting a retail item may include trying on an item of apparel in a fitting room at a physical retail store. The number of consumer inspections of the retail item can be measured at the offline location and used to develop various metrics associated with the retail item and/or the promotion thereof. For example, rejected items of apparel in a fitting room at a retail store can be scanned (e.g., by employees using a bar code scanner) to measure a number of consumer inspections of the retail items. The number of consumer inspections for a retail item may indicate a consumer interest in the item which is not necessarily reflected in consumer purchase data.

The systems and methods described herein may be used to measure an offline impact of online content (e.g., online advertising content). For example, the offline consumer inspection data may be combined with data associated with the online content (e.g., a number of impressions of the online content, an amount spent by a content provider to promote the retail item online, etc.) to determine an effectiveness of the online content. In some implementations, the offline consumer inspection data may be used to generate various inspection-related metrics for a retail item. Inspection-related metrics may include, for example, an effective advertising cost per consumer inspection of the retail item, a number of consumer inspections per impression of the online content, and/or a predicted inspection rate for the online content. The inspection-related metrics derived from the consumer inspection data can be used to determine a pricing value for the online content and/or a ranking for the online content (e.g., a value ranking, a cost ranking, an effectiveness ranking, etc.). The inspection-related metrics may be exposed to a content provider associated with the online content.

Content providers may use the systems and methods described herein to more accurately calculate target bids for online content (e.g., bids on an available impression for presenting the online content). Bids calculated using the systems and methods of the present disclosure may be based on consumer inspection data, which provides a more direct measurement of the offline impact of online content than consumer purchase data or other conversion metrics. Basing target bids on consumer inspection data may allow content providers to more effectively use an advertising budged by allocating more of the budget to online content that has the greatest impact on consumer inspections.

The systems and methods of the present disclosure may be used by retailers and other merchants to more effectively price and promote various retail items. The inspection-related metrics can help distinguish between retail items which have similar promotion and consumer purchase metrics. For example, if a first retail item has a significantly higher inspection rate than a second retail item, the systems and methods of the present disclosure may be used to determine that the first retail item can likely be sold at a higher price than the second retail item, even if both items have similar sales figures.

In some implementations, the consumer inspection data may be used by merchants to diagnose issues which result in poor sales figures. For example, if a retail item has an abnormally low inspection rate, it can be determined that there may be issues with the item or the promotion thereof (e.g., in the store, in advertisements, etc.). By conducting an experiment (e.g., moving the retail item to a new location in the store, using new advertising strategies, etc.) the effectiveness of various promotional strategies can be assessed using the consumer inspection data. If an item has a high inspection rate but a low sales rate, it can be determined that consumer interest is not the issue. For example, a high inspection rate but a low sales rate may indicate that consumers are interested in the retail item, but are deterred from purchasing the item for other reasons such as pricing or fitting.

By comparing the consumer inspection data and consumer purchase data across different stores, potential store-related issues can be identified. For example, a store with a high consumer inspection rate but a low consumer purchase rate may indicate that the sales personnel at the store are less effective at selling items than the sales personnel at other stores. A low consumer inspection rate may indicate that the store has a low number of customers.

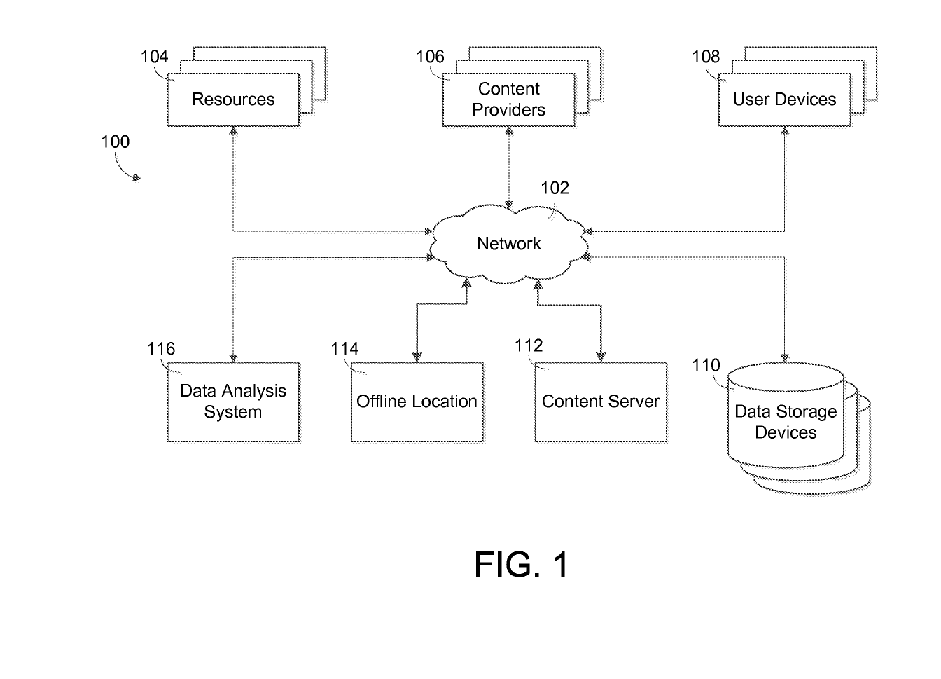

Referring now to FIG. 1, a block diagram of a computing system 100 is shown, according to a described implementation. In brief overview, computing system 100 is shown to include a network 102, resources 104, content providers 106, user devices 108, data storage devices 110, a content server 112, an offline location 114, and a data analysis system 116. Content providers 106 may generate third-party content (e.g., advertising content) which features or promotes a retail item. Content server 112 may provide the third-party content to user devices 108 in conjunction with first-party content from resources 104. A user of user devices 108 may travel to offline location 114 and inspect the retail item. At offline location 114, consumer inspection data may be collected and provided to data analysis system 116. Data analysis system 114 may use the consumer inspection data to determine an offline impact of the online third-party content.

It should be noted that although the various components of computing system 100 are shown and described separately with reference to FIG. 1, in some implementations, one or more components of computing system 100 may be combined into a single component. For example, content server 112 and data analysis system 116 may be combined into a single server or server system. As another example, data storage devices 110 may be combined with content server 112, data analysis system 116, or content providers 106. Data analysis system 116 may be located at offline location 114 or at a different location (e.g., integrated with content providers 106 or with user devices 108).

Computing system 100 may facilitate communication between resources 104, content providers 106, and user devices 108. For example, user devices 108 may request and receive first-party resource content (e.g., web pages, documents, etc.) from resources 104 via network 102. In some implementations, resources 104 include content item slots for presenting third-party content items from content providers 106. When resource content is viewed by user devices 108, third-party content items from content providers 106 may be delivered and presented in the content slots of resources 104.

Computing system 100 may also facilitate communication between resources 104, content providers 106, content server 112. For example, content server 112 may receive a notification of an available impression from resources 104 when resource content is loaded or viewed by user devices 108. Content server 112 may expose the available impression to content providers 106 and allow content providers 106 the opportunity to bid on the available impression. Content server 112 may select a third-party content item for presentation in a content slot of resources 104 based on the bids received from content providers 106.

Computing system 100 may also facilitate communication between content providers 106, offline location 114, and data analysis system 116. For example, consumer inspection data may be collected at offline location 114 and provided to data analysis system 116. Data analysis system 116 may analyze the consumer inspection data to generate various inspection-related metrics. Data analysis system 116 may expose the inspection-related metrics to content providers 106 and/or merchants at offline location 114.

Still referring to FIG. 1, computing system 100 is shown to include a network 102. Network 102 may be a local area network (LAN), a wide area network (WAN), a cellular network, a satellite network, a radio network, the Internet, or any other type of data network or combination thereof. Network 102 may include any number of computing devices (e.g., computers, servers, routers, network switches, etc.) configured to transmit, receive, or relay data. Network 102 may further include any number of hardwired and/or wireless connections. For example, user devices 108 may communicate wirelessly (e.g., via WiFi, cellular, radio, etc.) with a transceiver that is hardwired (e.g., via a fiber optic cable, a CAT5 cable, etc.) to a computing device of network 102.

Still referring to FIG. 1, computing system 100 is shown to include resources 104. Resources 104 may include any type of information or data structure that can be provided over network 102. In some implementations, resources 104 may be identified by a resource address associated with each resource (e.g., a uniform resource locator (URL)). Resources 104 may include web pages (e.g., HTML web pages, PHP web pages, etc.), word processing documents, portable document format (PDF) documents, images, video, programming elements, interactive content, streaming video/audio sources, or other types of electronic information. Resources 104 may include content (e.g., words, phrases, images, sounds, etc.) having embedded information (e.g., meta-information embedded in hyperlinks) and/or embedded instructions. Embedded instructions may include computer-readable instructions (e.g., software code, JavaScript®, ECMAScript®, etc.) which are executed by user devices 108 (e.g., by a web browser running on user devices 108).

Resources 104 may include a variety of content elements. For example, content elements may include, textual content elements (e.g., text boxes, paragraph text, text snippets, etc.), image content elements (e.g., pictures, graphics, etc.), video content elements (e.g., streaming video, moving graphics, etc.), hyperlink content elements (e.g., links to webpages, links to other resources, etc.), or any other type of content element that is visible when resources 104 are viewed and/or loaded by user devices 108. Content elements can be arranged in close proximity to each other (i.e., a high content element density) or more sparsely distributed (i.e., a low content element density). Content elements can have various sizes, positions, orientations, or other attributes defining how content elements are displayed on resources 104.

In some implementations, resources 104 may be represented by a document object model. The document object model may be a hierarchical model of resources 104. The document object model may include image information (e.g., image URLs, display positions, display sizes, alt text, etc.), font information (e.g., font names, sizes, effects, etc.), color information (e.g., RGB color values, hexadecimal color codes, etc.), text information, or other information affecting the visual appearance of resources 104 when resources 104 are fully loaded.

In some implementations, resources 104 may include content slots for presenting third-party content items. For example, resources 104 may include one or more inline frame elements (e.g., HTML “iframe” elements, <iframe> . . . </iframe>) for presenting third-party content items from content providers 106. An inline frame can be the “target” frame for links defined by other elements and can be selected by user agents (e.g., user devices 108, a web browser running on user devices 108, etc.) as the focus for printing, viewing its source, or other forms of user interaction. The content slots may cause user devices 108 to request third-party content items in response to viewing first-party resource content from resources 104.

Still referring to FIG. 1, computing system 100 is shown to include content providers 106. Content providers 106 may include one or more electronic devices representing advertisers, business owners, advertising agencies, or other entities capable of generating third-party content to be presented along with first-party content from resources 104. In some implementations, content providers 106 produce third-party content items (e.g., advertising content) for presentation to user devices 108. In other implementations, content providers 106 may submit a request to have third-party content items automatically generated. The third-party content items may be stored in one or more data storage devices local to content providers 106, within content server 112, or in data storage devices 110.

In some implementations, the third-party content items may be advertisements. The advertisements may be display advertisements such as image advertisements, animated advertisements, video advertisements, text-based advertisements, or any combination thereof. In other implementations, the third-party content items may include other types of content which serve various non-advertising purposes. The third-party content items may be displayed in a content slot of resources 104 and presented (e.g., alongside other resource content) to user devices 108.

In some implementations, content providers 106 may submit campaign parameters to content server 112. The campaign parameters may be used to control the distribution of third-party content items to user devices 108. The campaign parameters may include keywords associated with the third-party content items, bids corresponding to the keywords, a content distribution budget, geographic limiters, or other criteria used by content server 112 to specify the conditions under which a third-party content item may be presented to user devices 108.

Content providers 106 may access content server 112 and/or data analysis system 116 to monitor the performance of the third-party content items distributed according to the established campaign parameters. For example, content providers 106 may access content server 112 to review one or more performance metrics associated with a third-party content item or set of third-party content items (e.g., number of impressions, number of clicks, number of conversions, an amount spent, etc.).

The effectiveness of online content can be measured by various performance metrics such as a cost per impression (CPI) or a cost per thousand impressions (CPM). An impression may be counted, for example, whenever content server 112 records that a third-party content item was viewed by user devices 108. Some of the impressions may lead to user devices 108 interacting with the third-party content (e.g., clicking on a content item). A click-through rate (CTR) metric may be defined as the number of clicks on a third-party content item divided by the number of impressions.

The performance metrics may indicate an effectiveness of the third-party content with respect to one or more offline factors. For example, the performance metrics may include inspection-related metrics for a retail item associated with the third-party content. The inspection-related metrics may be based on a number of consumer inspections of the retail item at a physical store or other offline location. For example, inspection-related metrics may include an effective advertising cost per consumer inspection of the retail item at the offline location (CPN), a number of consumer inspections per impression of the online content (NPI), and/or a predicted inspection rate for the online content (pNPI). The performance metrics may be calculated by data analysis system 116 and exposed to content providers 106 (e.g., via a frontend management interface, as part of a programmatic bidding system, etc.).

Still referring to FIG. 1, computing system 100 is shown to include user devices 108. User devices 108 may include any number and/or type of user-operable electronic devices. For example, user devices 108 may include desktop computers, laptop computers, smartphones, tablets, mobile communication devices, remote workstations, client terminals, entertainment consoles, or any other devices capable of interacting with the other components of computing system 100 (e.g., via a communications interface). User devices 108 may be capable of receiving resource content from resources 104 and/or third-party content items from content providers 106 or content server 112. User devices 108 may include mobile devices or non-mobile devices.

In some implementations, user devices 108 include an application (e.g., a web browser, a resource renderer, etc.) for converting electronic content into a user-comprehensible format (e.g., visual, aural, graphical, etc.). User devices 108 may include a user interface element (e.g., an electronic display, a speaker, a keyboard, a mouse, a microphone, a printer, etc.) for presenting content to a user, receiving user input, or facilitating user interaction with electronic content (e.g., clicking on a content item, hovering over a content item, etc.). User devices 108 may function as a user agent for allowing a user to view HTML encoded content.

User devices 108 may include a processor capable of processing embedded information (e.g., meta information embedded in hyperlinks, etc.) and executing embedded instructions. Embedded instructions may include computer-readable instructions (e.g., software code, computer script, etc.) associated with a content slot within which a third-party content item is presented.

In some implementations, user devices 108 are capable of detecting an interaction with a distributed content item. An interaction with a content item may include displaying the content item, hovering over the content item, clicking on the content item, viewing source information for the content item, or any other type of interaction between user devices 108 and a content item. Interaction with a content item does not require explicit action by a user with respect to a particular content item. In some implementations, an impression (e.g., displaying or presenting the content item) may qualify as an interaction. The criteria for defining which user actions (e.g., active or passive) qualify as an interaction may be determined on an individual basis (e.g., for each content item), by content providers 106, or by content server 112.

User devices 108 may generate a variety of user actions. For example, user devices 108 may generate a user action in response to a detected interaction with a content item. The user action may include a plurality of attributes including a content identifier (e.g., a content ID or signature element), a device identifier, a referring URL identifier, a timestamp, or any other attributes describing the interaction. User devices 108 may generate user actions when particular actions are performed by a user device (e.g., resource views, online purchases, search queries submitted, etc.). The user actions generated by user devices 108 may be communicated to content server 112 and/or data analysis system 116.

For situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated (e.g., by content server 112 and/or by data analysis system 116) in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, a user may have control over how information is collected (e.g., by an application, by user devices 108, etc.) and used by content server 112 or data analysis system 116.

Still referring to FIG. 1, computing system 100 is shown to include data storage devices 110. Data storage devices 110 may be any type of memory device capable of storing profile data, content item data, accounting data, or any other type of data used by content server 112, data analysis system 116, or another component of computing system 100. Data storage devices 110 may include any type of non-volatile memory, media, or memory devices. For example, data storage devices 110 may include semiconductor memory devices (e.g., EPROM, EEPROM, flash memory devices, etc.) magnetic disks (e.g., internal hard disks, removable disks, etc.), magneto-optical disks, and/or CD ROM and DVD-ROM disks.

In some implementations, data storage devices 110 are local to content server 112, offline location 114, data analysis system 116, or content providers 106. In other implementations, data storage devices 110 are remote data storage devices connected with content server 112, offline location 114, data analysis system 116, or content providers 106 via network 102. In some implementations, data storage devices 110 are part of a data storage server or system capable of receiving and responding to queries from content server 112, data analysis system 116, and/or content providers 106

In some implementations, data storage devices 110 are configured to store consumer inspection data received from offline location 114. Consumer inspection data may be collected at offline location 114 (e.g., by employees and/or consumers at a retail store) and communicated to data storage devices 110. For example, employees at an apparel store may scan (e.g., using a bar code scanner) rejected items of apparel left in a fitting room. Consumer inspection data may indicate a consumer interest in a retail item which is not necessarily reflected in consumer purchase data for the retail item. Data storage devices 110 may store the consumer inspection data for use in generating one or more inspection-related metrics.

In some implementations, data storage devices 110 are configured to store consumer purchase data received from offline location 114. Consumer purchase data may be collected at offline location 114 (e.g., by a payment or check-out system at a retail store) and communicated to data storage devices 110. Consumer purchase data may indicate a number of consumer purchases of a retail item at the offline location. Data storage devices 110 may store the consumer inspection data and/or the consumer purchase data for subsequent retrieval and analysis data analysis system 116.

In some implementations, data storage devices 110 are configured to store one or more inspection-related metrics for various retail items. The inspection-related metrics may be generated by data analysis system 116 using the consumer inspection data obtained from offline location 114 and stored in data storage devices 110. Data storage devices 110 may store the inspection-related metrics for subsequent retrieval and use. For example, the inspection-related metrics may be retrieved from data storage devices 110 by content server 112 and exposed to content providers 106 as part of a programmatic bidding process. The inspection-related metrics may also be exposed to retailers/merchants at offline location 114.

Still referring to FIG. 1, computing system 100 is shown to include a content server 112. Content server 112 may receive a notification of an available impression from resources 104 and/or user devices 108. The notification of an available impression may be received in response to first-party content from resources 104 being viewed and/or loaded by user devices 108. The notification of an available impression may include a request for a third-party content item. In some implementations, the notification of an available impression includes characteristics of one or more content slots in which a third-party content item will be displayed. For example, such characteristics may include the URL of the resource 104 in which the content slot is located, a display size of the content slot, a position of the content slot, and/or media types that are available for presentation in the content slot. If the content slot is located on a search results page, keywords associated with the search query may also be provided to content server 112. The characteristics of the content slot and/or keywords associated with the content request may facilitate identification of content items that are relevant to resources 104 and/or to the search query.

Content server 112 may be configured to identify a particular retail item associated with various third-party content items. For example, content server 112 may identify a particular retail product or service featured or promoted in a third-party content item. Content server 112 may retrieve inspection-related metrics for the identified retail item from data storage devices 110. The inspection-related metrics may include one or more metrics based on the consumer inspection data received from offline location 114. Content server 112 may expose the available impression to content providers 106 and allow content providers 106 to bid on the available impression (e.g., programmatically as part of a real-time bidding system).

In some implementations, content server 112 exposes the inspection-related metrics for the identified retail item to content providers 106 along with the available impression. Content providers 106 may choose to consider or ignore the inspection-related metrics when bidding on the available impression. In some implementations, content server 112 uses the inspection-related metrics to generate a quality signal. The quality signal may be based on the inspection-related metrics along with one or more other indications of an estimated return on investment associated with the impression (e.g., an established click-through-rate (CTR), a predicted click-through-rate (pCTR), etc.). The quality signal may be a general quality signal for the identified retail item, a particular quality signal for the available impression, or an individualized quality signal for the available impression and a particular retail item. Content server 112 may provide the quality signal to content providers 106 to consider when bidding on the available impression.

In some implementations, content server 112 uses the inspection-related metrics to generate an individualized quality signal for the available impression with respect to a particular retail item. Content server 112 may consider a plurality of factors when generating an individualized quality signal for a retail item. For example, content server 112 may consider whether the retail item is relevant to the first-party resource content in conjunction with which the associated third-party content item would be presented. Content server 112 may generate a quality signal by comparing keywords associated with the retail item (e.g., specified by content providers 106, additional keywords extracted from the third-party content, etc.) with the keywords associated with the resource 104. A topic or type of content included in resources 104 may be used to establish keywords for resources 104.

In some implementations, content server 112 generates a quality signal for a retail item by considering whether the retail item is relevant to the user device 108 to which the content item will be presented. For example, content server 112 may compare the keywords associated with the retail item with information (e.g., profile data, user preferences, etc.) associated with a particular user device 108.

Content server 112 may auction the available impression to content providers 106. Content providers 106 may use the inspection-related metrics and/or quality signals to bid on the available impression. In some implementations, content server 112 automatically increases or decreases bid prices (e.g., starting bids, maximum bids, actual bids received from content providers 106, etc.) based on the inspection-related metrics for the identified retail item. In some implementations, content server 112 uses the inspection-related metrics to determine a pricing value for a third-party content item. Content server 112 may use the pricing value for a third-party content item to determine a target bid.

In some implementations, content server 112 determines a pricing value for a third-party content item as a cost per action (CPA). The actions may include online actions and/or offline actions. For example, online actions may include interacting with the third-party content item (e.g., clicking on the third-party content item or a link therein) or making an online purchase of the retail item featured in the third-party content, user identifiers' referring the advertisement to other user identifiers, etc. Content server 112 may determine a pricing value as cost per click-through (CPC; counted when a third-party content item is clicked), cost per sale (CPS), and/or cost per lead (CPL). Sometimes an effective CPM (eCPM) may be used to measure the effectiveness of third-party content, where actual actions such as clicks may be factored into the calculation.

Content server 112 may select an eligible third-party content item based on a result of the auction. For example, content server 112 may select an eligible content item associated with the content provider that submits the highest bid. In some implementations, eligible content items include content items having characteristics matching the characteristics of the content slots in which the content items are to be presented. For example, content server 112 may select a content item having a display size which fits in a destination content slot. Content server 112 may resize a selected content item to fit a content slot or add additional visual content to the selected content item (e.g., padding, a border, etc.) based on the display size of the content item and the display size of the content slot. In some implementations, eligible content items include content items matching established user preferences for receiving individualized content; however, content server 112 may select a content item that does not match established user preferences if an insufficient number of preferred content items are available.

Content server 112 may deliver the selected third-party content item to user devices 108. In some implementations, the selected third-party content item is presented in conjunction with first-party content from resources 104. A user may view the online content via user devices 108. In some implementations, the user travels to offline location 114 and inspects the retail item associated with the online content.

Still referring to FIG. 1, computing system 110 is shown to include an offline location 114. Offline location 114 may be a location at which offline actions are performed. In general, the term “online” indicates a state of connectivity (e.g., to the Internet), while “offline” indicates a disconnected state. Online actions may occur during a web browsing session through which the online content is viewed. For example, online actions may include viewing online content, clicking on a third-party content item during a web browsing session, visiting a website associated with content providers 106, and making an online purchase of a retail item. Offline actions may occur outside of a web browsing session. Examples of offline actions include traveling to a physical store, inspecting retail items at the physical store, making offline purchases (e.g., at offline location 114), and other activities relating to products or services outside of the Internet session through which the online content is viewed.

In some implementations, offline location 114 is a physical store. For example, offline location 114 may be a retail outlet, a grocery store, a market, a pharmacy, a service center, a sales kiosk or booth, a storefront, or any other location at which retail items (e.g., products, services, articles of commerce, etc.) can be bought or sold. In various implementations, offline location 114 may be configured to receive customers physically (e.g., at a physical store) or may interact with customers remotely (e.g., via telephone calls).

Offline location 114 may be configured to collect consumer inspection data for various retail items. Consumer inspection data may include a number of times a retail item is inspected by consumers at offline location 114. For example, if offline location 114 is an apparel store, consumer inspection data may include a number of times various articles of apparel are tried on by consumers in a fitting room. Offline location 114 may be outfitted with electronic devices to automate the collection of consumer inspection data. For example, offline location 114 may include bar code scanners which can be used by store personnel to scan items rejected items of apparel in a fitting room. The consumer inspection data can be stored in data storage devices 110 and/or provided to data analysis system 116. In some implementations, the consumer inspection data include an item identifier for each consumer inspection. The item identifier may identify a particular retail item that is inspected at offline location 114.

Still referring to FIG. 1, computing system 100 is shown to include a data analysis system 116. Data analysis system 116 may be configured to receive consumer inspection data for various retail items. The consumer inspection data may be collected at offline location 114 and delivered to data analysis system 116. The consumer inspection data may indicate a number of times that a consumer item is inspected at offline location 114. Data analysis system 116 may use the consumer inspection data to generate an inspection-related metric for the retail item. The inspection-related metric may be a function of a number of consumer inspections of the retail item at offline location 114.

In some implementations, data analysis system 116 may identify a particular retail item associated with the consumer inspection data (e.g., using an item identifier included in the consumer inspection data). Data analysis system 116 may identify one or more third-party content items associated with the identified retail item. For example, if the identified retail item is a particular brand of shoes, data analysis system 116 may search for third-party content items that feature or promote the particular brand of shoes. Data analysis system 116 may store the inspection-related metrics as attributes of the identified retail item or as attributes of the identified third-party content associated therewith.

Data analysis system 116 may provide an analysis interface through which content providers 106 and/or other entities (e.g., merchants, store owners, etc.) can monitor the number of consumer inspections of various retail items. Data analysis system 116 may expose the inspection-related metrics to content providers 106 via the analysis interface. Data analysis system 116 may provide the inspection-related metrics to content providers 106 along with other metrics which can be analyzed in conjunction with the inspection-related metrics to generate an analytical report. For example, data analysis system 116 may analyze the number of consumer inspections of a retail item at offline location 114 (e.g., for a particular time period) in conjunction with a number of purchases of the retail item at offline location 114. Such a joint analysis may be used to determine an appropriate pricing strategy for the retail item or to diagnose issues in the sales performance of the retail item.

In some implementations, data analysis system 116 may analyze the number of consumer inspections of a retail item at offline location 114 in conjunction with online content data associated with the retail item. The online content data may include various metrics related to the delivery (e.g., to user devices 108) of online content associated with the retail item. For example, the online content data may indicate a number of impressions of the online content associated with the retail item, an amount spent promoting the retail item via the online content, a bids price for the online content, and/or other metrics for the online content associated with the retail item.

Data analysis system 116 may generate an inspection-related metric for the retail item which combines the consumer inspection data and the online content data. For example, data analysis system 116 may determine a number of consumer inspections per impression of associated online content (NPI), an amount spent promoting the retail item per consumer inspection (CPN), or other inspection-related metrics which combine the consumer inspection data and the online content data. Data analysis system 116 may use the consumer inspection data and the online content data to determine an effectiveness (e.g., an offline impact) of the online content.

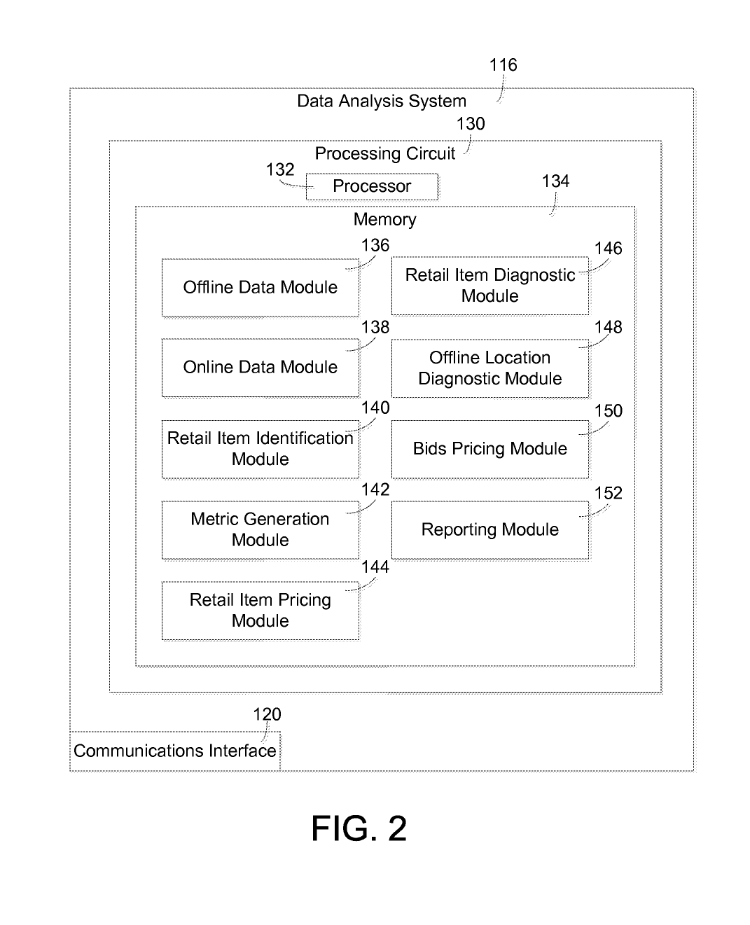

In some implementations, data analysis system 116 may be combined with content server 112. For example, a single combined system may deliver online content to user devices 108 and analyze the offline consumer inspection data collected at offline location 114. Data analysis system 116 is described in greater detail with reference to FIG. 2.

Referring now to FIG. 2, a block diagram illustrating data analysis system 116 in greater detail is shown, according to a described implementation. Data analysis system 116 is shown to include a communications interface 120 and a processing circuit 130. Communications interface 120 may include wired or wireless interfaces (e.g., jacks, antennas, transmitters, receivers, transceivers, wire terminals, Ethernet ports, WiFi transceivers, etc.) for conducting data communications with local or remote devices or systems. For example, communications interface 120 may allow data analysis system to communicate with network 102, resources 104, content providers 106, user devices 108, data storage devices 110, content server 112, and offline location 114.

Communications interface 130 may be configured to receive consumer inspection data for a retail item. The consumer inspection data may indicate a number of consumer inspections of the retail item at an offline location (e.g., offline location 114). The consumer inspection data may be collected at offline location 114 and communicated to data analysis system 116. The consumer inspection data may measure a consumer interest in the retail item at offline location 114 which is not necessarily reflected in consumer purchase data for the retail item.

In some implementations, communications interface 130 may receive consumer purchase data for the retail item. Consumer purchase data may be collected at offline location 114 (e.g., by a payment or check-out system at a retail store) and communicated to data analysis system 116. Consumer purchase data may indicate a number of consumer purchases of a retail item at offline location 114. In various implementations, communications interface 130 may receive the consumer inspection data and/or the consumer purchase data directly from offline location 114, from data storage devices 110, or via one or more intermediate components (e.g., network 102).

Communications interface 130 may receive online content data from content server 112. Online content data may include data relating to the delivery of online content (e.g., third-party content items from content server 112, resource content from resources 104, etc.) to user devices 108. In some implementations, online content data includes metrics associated with the delivery of third-party content items from content server 112 to user devices 108. For example, content server 112 may report to data analysis system 116 a number of impressions of various third-party content items, a number of user interactions with the third-party content items (e.g., clicks), a number of online conversions attributable to the third-party content items (e.g., online purchases), an amount spent by content providers 106 to deliver the third-party content items to user devices 108, a pricing value for the third-party content items, and/or other metrics associated with the delivery of third-party content items to user devices 108.

In some implementations, online content data includes metrics associated with the delivery of first-party content from resource 104 to user devices 108. For example, content server 112 may receive information from user devices 108 and/or resources 104 regarding first-party content delivered to user devices 108 (e.g., recently viewed webpages, browsing history, previous interactions with resources 104, etc.). Content server 112 and/or resources 104 may report to data analysis system 116 a number of impressions of first-party content from resources 104, a number of user interactions with first-party content, a number of online conversions (e.g., online purchases) made via resources 104, and/or other metrics associated with the delivery of first-party content from resources 104 to user devices 108.

Still referring to FIG. 2, processing circuit 130 is shown to include a processor 132 and memory 134. Processor 132 may be implemented as a general purpose processor, an application specific integrated circuit (ASIC), one or more field programmable gate arrays (FPGAs), a CPU, a GPU, a group of processing components, or other suitable electronic processing components.

Memory 134 may include one or more devices (e.g., RAM, ROM, flash memory, hard disk storage, etc.) for storing data and/or computer code for completing and/or facilitating the various processes, layers, and modules described in the present disclosure. Memory 134 may comprise volatile memory or non-volatile memory. Memory 134 may include database components, object code components, script components, or any other type of information structure for supporting the various activities and information structures described in the present disclosure. In some implementations, memory 134 is communicably connected to processor 132 via processing circuit 130 and includes computer code (e.g., data modules stored in memory 134) for executing one or more processes described herein. In brief overview, memory 134 is shown to include an offline data module 136, an online data module 138, a retail item identification module 140, a metric generation module 142, a retail item pricing module 144, a retail item diagnostic module 146, an offline location diagnostic module 148, a bids pricing module 150, and a reporting module 152.

Still referring to FIG. 2, memory 134 is shown to include an offline data module 136. Offline data module 136 may be configured to obtain offline data for various retail items. Offline data may include consumer inspection data (e.g., a number of times a retail item is inspected by consumers at offline location 114), consumer purchase data (e.g., a number of times a retail item is purchased by consumers at offline location 114), and/or other data collected at offline location 114. In various implementations, offline data module 136 obtains offline data from offline location 114 or data storage devices 110. Offline data module 136 may obtain offline data collected at a single offline location or multiple offline locations. For example, offline data module 136 may obtain offline data collected at multiple different store locations. The offline data may relate to a single retail item or multiple retail items.

In some implementations, the offline data obtained by offline data module 136 includes a plurality of data entries. Each data entry may represent an offline event which occurs at offline location 114. For example, the plurality of data entries may include inspection data entries representing consumer inspections of a retail item and/or purchase data entries representing consumer purchases of a retail item.

Each data entry may include one or more attributes describing details of the offline event represented by the data entry. For example, a data entry may include a time attribute indicating a time at which the offline event occurs, a type attribute indicating a type of event (e.g., inspection, purchase, etc.), an item ID attribute indicating a particular retail item to which the data entry applies, a store ID indicating a particular offline location at which the event occurs, and/or other attributes as may be relevant for different types of offline events. In some implementations, offline data module 136 organizes and/or classifies the offline data into one or more data sets. For example, offline data module 136 may separate the offline data into multiple data sets according to the value of a particular attribute (e.g., by event type, by time, by retail item ID, by store ID, etc.).

Still referring to FIG. 2, memory 134 is shown to include an online data module 138. Online data module 138 may be configured to obtain online content data for various retail items. Online content data may include metrics describing the delivery of online content to user devices 108. In some implementations, online content includes third-party content items delivered to user devices 108 from content server 112. Online data module 138 may obtain metrics describing a number of impressions of various third-party content items, a number of user interactions with the third-party content items (e.g., clicks), a number of online conversions attributable to the third-party content items (e.g., online purchases), an amount spent by content providers 106 to deliver the third-party content items to user devices 108, and/or other metrics associated with the delivery of third-party content items to user devices 108.

In some implementations, online content includes first-party content delivered to user devices 108 from resources 104. Online data module 138 may obtain metrics describing a number of impressions of first-party content from resources 104, a number of user interactions with first-party content, a number of online conversions (e.g., online purchases) made via resources 104, and/or other metrics associated with the delivery of first-party content from resources 104 to user devices 108. Online data module 136 may obtain online content data from a single data source (e.g., data storage devices 110) or multiple data sources (e.g., content server 112, user devices 108, resources 104, etc.). The online content data may relate to a single retail item or multiple retail items.

In some implementations, the online data obtained by online data module 138 includes a plurality of data entries. Each data entry may represent an online event. For example, the plurality of data entries may represent click events (e.g., clicking on a third-party content item), purchase events (e.g., making an online purchase), hover events, impression events, visit events (e.g., visiting a particular URL or webpage) and/or other types of events which may occur online.

Each data entry may include one or more attributes describing details of the online event represented by the data entry. For example, a data entry for an online event may include a time attribute indicating a time at which the online event occurs, a type attribute indicating a type of event (e.g., click, purchase, visit, etc.), a content item ID attribute indicating a particular third-party content item associated with the online event, a device ID indicating a particular user device associated with the event, a bid price associated with an impression event, and/or other attributes as may be relevant for different types of online events. In some implementations, online data module 138 organizes and/or classifies the online data into one or more data sets. For example, online data module 138 may separate the online data into multiple data sets according to the value of a particular attribute (e.g., by event type, by time, by content item ID, by device ID, etc.).

Still referring to FIG. 2, memory 134 is shown to include a retail item identification module 140. Retail item identification module 140 may be configured to identify one or more retail items associated with the offline data (e.g., consumer inspection data and/or consumer purchase data) obtained by offline data module 136. In some implementations, retail item identification module 140 may identify a retail item associated with each offline event. Retail item identification module 140 may use the attributes of each offline event to identify a particular retail item. For example, retail item identification module 140 may use an item identifier (e.g., the retail item ID attribute) of an offline event to determine the retail item associated with the event. In some implementations, retail item identification module 140 may reference a database or translation table to convert an item identifier into a user-comprehensible item name.

Retail item identification module 140 may be configured to identify one or more retail items associated with the online data obtained by online data module 138. In some implementations, retail item identification module 140 may identify a retail item associated with each online event. Retail item identification module 140 may use the attributes of each online event to identify a particular retail item. For example, retail item identification module 140 may use a content item identifier (e.g., the content item ID attribute) of an online event to determine a particular third-party content item associated with the event. Retail item identification module 140 may use attributes or keywords of the third-party content item to identify a particular retail item associated therewith. For example, retail item identification module 140 may identify the retail item promoted or featured in the third-party content item.

Still referring to FIG. 2, memory 134 is shown to include a metric generation module 142. Metric generation module 142 may be configured to create one or more metrics based on the online data and offline data obtained by data modules 138-140. For example, metric generation module 142 may create a “number of inspections” metric for a retail item. The number of inspections metric may represent a total number of times the retail item is inspected at offline location 114 within a time window. As another example, metric generation module 142 may create a metric representing a total amount that a content provider spent to promote a particular retail item within the time window. The total amount that the content provider has spent may be a summation of the amounts that the content provider has paid to deliver third-party content items which feature or promote the retail item.

In some implementations, metric generation module 142 generates an inspection-related metric for one or more of the retail items represented in the offline data. The inspection-related metric may be any metric which is a function of the consumer inspection data for a retail item. For example, one inspection-related metric may be a number of inspections of the retail item at a particular offline location (e.g., consumer inspections at Store A). Another inspection-related metric may represent the total amount spent promoting a retail item divided by the number of consumer inspections of the retail item (e.g., cost per inspection). Yet another inspection-related metric may be an inspection-to-purchase ratio for a retail item at a particular offline location (e.g., number of consumer inspections per consumer purchase at Store A).

In some implementations, metric generation module 142 exposes the inspection-related metrics to retailers or merchants associated with offline location 114. For example, a manager or owner of a retail store located at offline location 114 may interact with metric generation module 142 to view the inspection-related metrics for various retail items at the retail store. In some implementations, metric generation module 142 may be deployed as part of enterprise software provided to merchants or other retailers to allow the merchants/retailers to monitor consumer inspection data at their store locations. Retailers or merchants may use the inspection-related metrics provided by metric generation module 142 to determine an appropriate pricing value for a retail item, to diagnose issues in the sales performance for a retail item, and/or to diagnose issues in the sales performance for a particular offline location. In some implementations, retail item pricing and issue diagnostics may be performed automatically by modules 144-148.

In some implementations, metric generation module 142 exposes the inspection-related metrics to content providers 106. For example, content providers 106 may interact with metric generation module 142 (e.g., via a reporting or analysis interface) to view the inspection-related metrics for various retail items. In some implementations, metric generation module 142 may receive input from content providers 106 to generate customized inspection-related metrics for a retail item. The customized inspection-related metrics may be a function of the consumer inspection data and one or more additional metrics or parameters specified by content providers 106. Content providers 106 may use the inspection-related metrics to determine a pricing value for online content. For example, content providers 106 may use the inspection-related metrics to determine a target price for bidding on an opportunity to present a third-party content item which features the retail item (i.e., bidding on an available impression). In some implementations, bid pricing may be determined automatically by bids pricing module 150, described in greater detail below.

Still referring to FIG. 2, memory 134 is shown to include a retail item pricing module 144. Retail item pricing module 144 may use the consumer inspection data for a retail item to determine a pricing value for the retail item. Retail item pricing module 144 may use the consumer inspection data to distinguish between retail items which have similar sales figures. For example, if two retail items have similar sales figures but a significantly different number of consumer inspections, retail item pricing module 144 may determine that the retail item with the higher number of consumer inspections can be sold at a higher price than the retail item with the lower number of consumer inspections. A higher number of consumer inspections for a retail item may indicate a higher consumer interest which is not necessarily reflected in the consumer purchase data. Retail item pricing module 144 may be configured to calculate or suggest pricing values for various retail items based on the consumer inspection data.

Still referring to FIG. 2, memory 134 is shown to include a retail item diagnostic module 146. Retail item diagnostic module 146 may be configured to diagnose issues in the sales performance of retail items using the consumer inspection data. For example, retail item diagnostic module 146 may determine whether a poor sales performance for a retail item is attributable to the promotion of the retail item (e.g., in advertisements, placement of the retail item within a store, etc.) or whether the poor sales performance is attributable to an attribute of the retail item itself (e.g., pricing, fitting, etc.).

In some implementations, retail item diagnostic module 146 may compare a number of consumer inspections of a particular retail item with a number of consumer purchases of the retail item. If the number of consumer inspections greatly exceeds the number of consumer purchases (e.g., by an amount exceeding a threshold value), retail item diagnostic module 146 may determine that promotion of the retail item is not the issue. For example, a high number of consumer inspections may indicate that consumers are interested in the retail item but are deterred from purchasing the item for other reasons (e.g., pricing, fitting, poor economy, etc.).

In some implementations, retail item diagnostic module 146 may compare a number of consumer inspections of a particular retail item with a threshold value. If the number of consumer inspections is below the threshold value, retail item diagnostic module 146 may determine that an increase in promotional efforts is needed (e.g., more advertisements, more effective advertisements, a more prominent location in the store, etc.). If the number of consumer inspections improves upon an increase in promotional efforts, retail item diagnostic module 146 may determine that insufficient promotion was at least a partial cause of the poor sales performance.

Still referring to FIG. 2, memory 134 is shown to include an offline location diagnostic module 148. Offline location diagnostic module may be configured to diagnose location-related issues (e.g., store-related issues, geographic issues, etc.) in the sales performance of retail items using the consumer inspection data. For example, offline location diagnostic module 148 may compare offline data (e.g., consumer inspection data and/or consumer sales data) across multiple different offline locations (e.g., multiple different stores) to determine whether a poor sales performance is attributable to a location-specific factor.

In some implementations, offline location diagnostic module 148 may compare an inspection-to-sales ratio across multiple different offline locations. The inspection-to-sales ratio may be a number of consumer inspections of a retail item at a particular offline location divided by a number of consumer purchases of the retail item at the offline location. In various implementations, the inspection-to-sales ratio may be generated by metric generation module 142 or offline location diagnostic module 148. If the inspection-to-sales ratio for a first offline location is significantly higher than the inspection-to-sales ratio for a second offline location (e.g., if the difference between the ratios exceeds a threshold value), offline location diagnostic module 148 may determine that the first offline location is less effective at converting consumer inspections into consumer sales than the second offline location. This comparison may be especially relevant for businesses wherein consumers frequently visit multiple different locations before making a purchase (e.g., an automobile dealership).

In some implementations, offline location diagnostic module 148 may compare a number of consumer inspections across multiple different offline locations. If a first offline location has a significantly lower number of consumer inspections than a second offline location (e.g., if the difference between the number of consumer inspections exceeds a threshold value), offline location diagnostic module 148 may determine that the first offline location has less customers than the second location. If both locations have similar or shared advertising, offline location diagnostic module 148 may determine that the first offline location is less desirable than the second offline location for geographic or store-related reasons.

Still referring to FIG. 2, memory 134 is shown to include a bids pricing module 150. Bids pricing module 150 may be configured use the inspection-related metrics for a retail item to determine a pricing value for online content associated with the retail item. In some implementations, bids pricing module 150 may determine a number of consumer inspections at offline location 114 attributable to a particular third-party content item or a set of third-party content items (i.e., online content). For example, bids pricing module 150 may record a consumer inspection rate for a retail item at offline location 114 at a first time (e.g., before providing the online content) and a second time (e.g., after providing the online content). Bids pricing module 150 may determine that a difference in the consumer inspection rate between the first time and the second time is attributable to the online content provided in the interval between the first time and the second time.

Bids pricing module 150 may determine a monetary value of an increase in consumer inspections attributable to the online content. Bids pricing module 150 may calculate the monetary value of the increase by multiplying a magnitude of the increase in consumer inspections by a variable representing a monetary value per consumer inspection. The monetary value per consumer inspection may be provided by content providers 106 or calculated based on an expected inspection-to-sales ratio for the retail item.

Bids pricing module 150 may use the monetary value of the increase in consumer inspections to determine a pricing value for the online content. For example, bids pricing module 150 may determine a pricing value for the online content which is less than or equal to the monetary value of the increase in consumer inspections. The pricing value for the online content may define a maximum advertising budget to spend promoting the retail item. Bids pricing module 150 may use the pricing value of the online content to determine a target bid for the online content (e.g., a bid on an available impression for submission as part of a programmatic auction).

Bids pricing module 150 may be used (e.g., by content providers 106) to more accurately calculate target bids for online content. The bids calculated by bids pricing module 150 may be based on consumer inspection data, which more directly measures an offline impact of the online content than consumer purchase data. The bids calculated by bids pricing module 150 may allow content providers 106 to more effectively use an advertising budged by allocating more of the budget to online content that has the greatest impact on consumer inspections.

Still referring to FIG. 2, memory 134 is shown to include a reporting module 152. Reporting module 152 may be configured to use the consumer inspection data to generate an analytical report. The analytical report may indicate an offline impact of online content. Reporting module 152 may express the offline impact of online content as a function of the consumer inspection data (e.g., as a function of the number of consumer inspections, a function of an inspection-related metric derived from a number of consumer inspections, etc.) associated with the online content. Content providers 106, retailers, and other merchants may interact with reporting module 152 to view the inspection-related metrics for particular retail items and/or the online content associated therewith. In some implementations, reporting module 152 exposes the inspection related metrics to content providers 106.

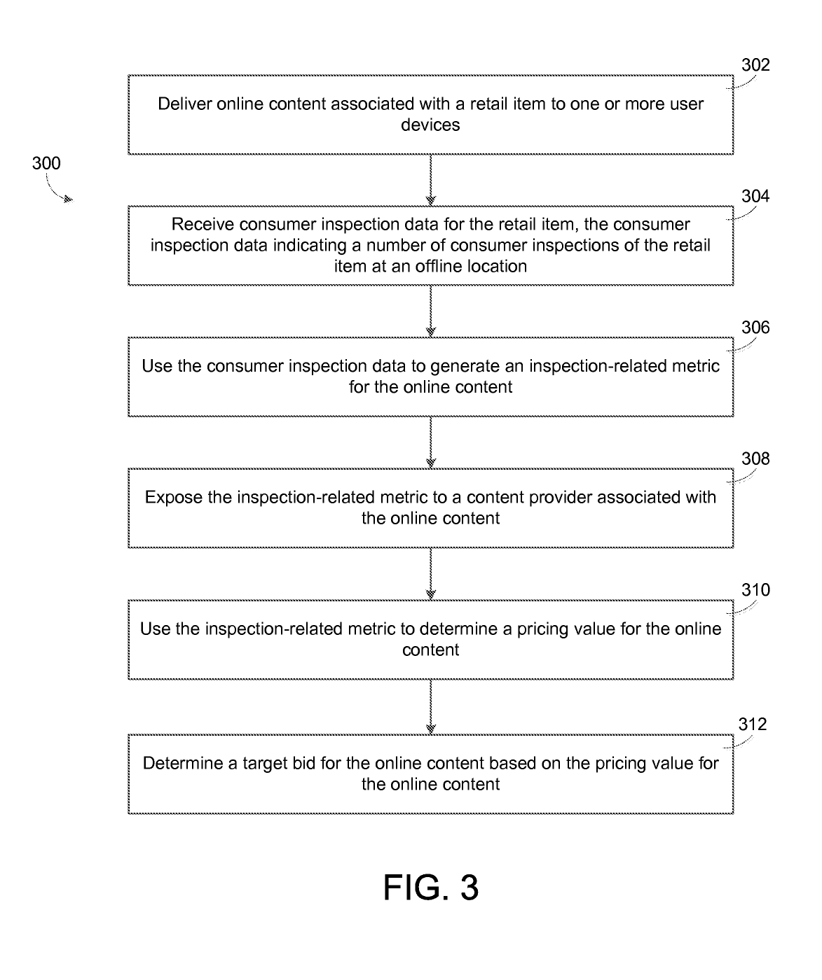

Referring now to FIG. 3, a flowchart of a process 300 for measuring an offline impact of online content is shown, according to a described implementation. Process 300 may be performed by one or more components of computing system 100, as described with reference to FIGS. 1-2. In some implementations, process 300 may be performed by content server 112 and/or data analysis system 116. In some implementations, process 300 may be performed by a combined system which includes the functionality of both content server 112 and data analysis system 116.

Still referring to FIG. 3, process 300 is shown to include delivering online content associated with a retail item to one or more user devices (step 302). In some implementations, the online content is third-party content delivered by content server 112 to one or more of user devices 108. For example, the online content may be advertising content which features or promotes a retail item. In some implementations, the online content is first-party content delivered by resources 104 to one or more of user devices 108. For example, the online content may be a webpage or website related to the retail item, a consumer review of the retail item, or other resource content which features or promotes the retail item.

In some implementations, step 302 is performed in response to a notification of an available impression from resources 104 and/or user devices 108. The notification of an available impression may include a request for a third-party content item. In some implementations, the notification of an available impression includes characteristics of one or more content slots in which a third-party content item will be displayed. For example, such characteristics may include the URL of the resource 104 in which the content slot is located, a display size of the content slot, a position of the content slot, and/or media types that are available for presentation in the content slot. If the content slot is located on a search results page, keywords associated with the search query may also be provided. The characteristics of the content slot and/or keywords associated with the content request may facilitate identification of content items that are relevant to resources 104 and/or to the search query.

In some implementations, step 302 includes selecting content items which have characteristics matching the characteristics of the content slots in which the content items are to be presented. For example, step 302 may include selecting a content item having a display size which fits in a destination content slot. Step 302 may include resizing a selected content item to fit a content slot or add additional visual content to the selected content item (e.g., padding, a border, etc.) based on the display size of the content item and the display size of the content slot. In some implementations, eligible content items include content items matching established user preferences for receiving individualized content; however, step 302 may include selecting a content item that does not match established user preferences if an insufficient number of preferred content items are available.

In some implementations, step 302 includes delivering a relevant third-party content item to user devices 108. In some implementations, step 302 includes generating a quality signal for a third-party content item by considering whether the third-party content item is relevant to the user device 108 to which the content item will be delivered. For example, step 302 may include comparing keywords associated with the content item with information (e.g., profile data, user preferences, etc.) associated with a particular user device 108.

In some implementations, step 302 includes auctioning the available impression to content providers 106. Content providers 106 may bid on the available impression by submitting bids. Step 302 may include selecting a third-party content item based on a result of the auction. For example, step 302 may select a content item associated with the content provider that submits the highest bid.

Step 302 may include delivering the selected third-party content item to user devices 108. In some implementations, the selected third-party content item is presented in conjunction with first-party content from resources 104. In some implementations, step 302 includes identifying a particular retail item associated with the delivered online content. For example, step 302 may include identifying a particular retail product or service featured or promoted in a third-party content item delivered to user devices 108. A user may view the online content via user devices 108. In some implementations, the user travels to an offline location and inspects the retail item associated with the online content. In some implementations, step 302 is an optional step and process 300 may begin with step 304.

Still referring to FIG. 3, process 300 is shown to include receiving consumer inspection data for the retail item (step 304). The consumer inspection data may indicate a number of consumer inspections of the retail item at an offline location (e.g., offline location 114). The consumer inspection data may be collected at the offline location. The consumer inspection data may measure a consumer interest in the retail item at the offline location which is not necessarily reflected in consumer purchase data for the retail item. For example, consumer inspection data may indicate a number of times the retail item is tested, tried on, used, or otherwise inspected at the offline location. A consumer inspection may include, for example, trying on an article of apparel at a clothing store, test driving an automobile at an automobile dealership, asking a store employee for more information regarding a particular retail item, or otherwise viewing or inspecting the retail item at the offline location.

In various implementations, step 304 may include receiving consumer inspection data from the offline location, from data storage devices 110, or from user devices 108. For example, in some implementations, store personnel may scan rejected items of apparel left in a fitting room at a physical apparel store (e.g., using a bar code scanner or other automated scanning instrument). In some implementations, user devices 108 may provide offline inspection data in step 304. For example, portable user devices (e.g., smart phones, tablets, laptops, etc.) may be transported to the offline location and used to provide the consumer inspection data. Consumer inspection data may include data collected at a single offline location or multiple offline locations. For example, consumer inspection data may include offline data collected at multiple different store locations. The offline data may relate to a single retail item or multiple retail items.

In some implementations, step 304 includes receiving consumer purchase data for the retail item. Consumer purchase data may be collected at the offline location (e.g., by a payment or check-out system at a retail store) and received in step 304. Consumer purchase data may indicate a number of consumer purchases of a retail item at the offline location. In various implementations, step 304 may include receiving the consumer inspection data and/or the consumer purchase data directly from the offline location, from data storage devices 110, or via one or more intermediate components (e.g., network 102). Consumer purchase data and consumer inspection data may be offline data representing offline activities performed at the offline location.

In some implementations, the offline data obtained received in step 304 includes a plurality of data entries. Each data entry may represent an offline event which occurs at the offline location. For example, the plurality of data entries may include inspection data entries representing consumer inspections of a retail item at the offline location. The plurality of data entries may also include purchase data entries representing consumer purchases of a retail item at the offline location.

Each data entry may include one or more attributes describing details of the offline event represented by the data entry. For example, a data entry may include a time attribute indicating a time at which the offline event occurs, a type attribute indicating a type of event (e.g., inspection, purchase, etc.), an item ID attribute indicating a particular retail item to which the data entry applies, a location ID indicating a particular offline location at which the event occurs, and/or other attributes as may be relevant for different types of offline events. In some implementations, step 304 includes organizing or classifying the offline data into one or more data sets. For example, step 304 may include separating the offline data into multiple data sets according to the value of a particular attribute (e.g., by event type, by time, by retail item ID, by store ID, etc.).

Still referring to FIG. 3, process 300 is shown to include using the consumer inspection data to generate an inspection-related metric for the online content (step 306). The inspection-related metric may correspond to a particular retail item represented in the consumer inspection data. The inspection-related metric may be any metric which is a function of the consumer inspection data for a retail item. For example, one inspection-related metric may be a number of inspections of the retail item at a particular offline location (e.g., consumer inspections at Store A). Another inspection-related metric may represent the total amount spent promoting a retail item divided by the number of consumer inspections of the retail item (e.g., cost per inspection). Yet another inspection-related metric may be an inspection-to-purchase ratio for a retail item at a particular offline location (e.g., number of consumer inspections per consumer purchase at Store A).

In some implementations, step 306 includes associating the inspection-related metric with the online content. For example, the online content may be associated with one or more data entries representing online events. Each data entry may include one or more attributes describing details of the online event represented by the data entry. For example, a data entry for an online event may include a time attribute indicating a time at which the online event occurs, a type attribute indicating a type of event (e.g., click, purchase, visit, etc.), a content item ID attribute indicating a particular third-party content item associated with the online event, a device ID indicating a particular user device associated with the event, a bid price associated with an impression event, and/or other attributes as may be relevant for different types of online events. Step 306 may include identifying a retail item featured or promoted in the online content (e.g., using the attributes of the online events). If the retail item featured or promoted in the online content matches the retail item to which the inspection-related metric relates, the inspection-related metric may be associated with the online content.

Still referring to FIG. 3, process 300 is shown to include exposing the inspection-related metric to a content provider associated with the online content (step 308). In some implementations, step 308 includes using a reporting or analysis interface to provide the inspection-related metric to content providers 106. For example, content providers 106 may interact with data analysis system 116 to view the inspection-related metrics for various retail items. In some implementations, step 308 includes using the inspection-related metric to determine a quality signal for a particular retail item. The quality signal may be provided to content providers 106 along with a notification of an available impression. Content providers 106 may use the quality signal to determine a pricing value for online content associated with the retail item and/or to calculate target bids for the online content.

In some implementations, step 308 includes exposing the inspection-related metrics to retailers or merchants associated with the offline location. For example, a manager or owner of a retail store located at the offline location may interact with data analysis system 116 to view the inspection-related metrics for various retail items at the retail store. Exposing the inspection-related metrics to merchants and retailers may allow the merchants/retailers to monitor consumer inspection data at their store locations. Retailers or merchants may use the inspection-related metrics exposed in step 308 to determine an appropriate pricing value for a retail item, to diagnose issues in the sales performance for a retail item, and/or to diagnose issues in the sales performance for a particular offline location.

Still referring to FIG. 3, process 300 is shown to include using the inspection-related metric to determine a pricing value for the online content (step 310). In some implementations, step 310 includes determining a number of consumer inspections at the offline location which are attributable to the online content (e.g., attributable to a particular third-party content item or a set of third-party content items). For example, step 310 may include recording a consumer inspection rate for a retail item at the offline location at a first time (e.g., before providing the online content) and a second time (e.g., after providing the online content). Step 310 may include determining that a difference in the consumer inspection rate between the first time and the second time is attributable to the online content provided in the interval between the first time and the second time.

In some implementations, step 310 includes determining a monetary value of an increase in consumer inspections attributable to the online content. For example, step 310 may include calculating the monetary value of the increase by multiplying a magnitude of the increase in consumer inspections by a variable representing a monetary value per consumer inspection. The monetary value per consumer inspection may be provided by content providers 106 or calculated based on an expected inspection-to-sales ratio for the retail item.

In some implementations, step 310 includes using the monetary value of the increase in consumer inspections to determine a pricing value for the online content. For example, step 310 may include determining a pricing value for the online content which is less than or equal to the monetary value of the increase in consumer inspections. The pricing value for the online content may define a maximum advertising budget to spend promoting the retail item.

Still referring to FIG. 3, process 300 is shown to include determining a target bid for the online content based on the pricing value for the online content (step 312). The target bid for the online content may include, for example, a bid on an available impression for submission as part of a programmatic auction. In some implementations, step 312 may be performed to more accurately calculate target bids for online content. The bids calculated in step 312 may be based on consumer inspection data, which more directly measures an offline impact of the online content than consumer purchase data. The bids calculated in step 312 may allow content providers to more effectively use an advertising budged by allocating more of the budget to online content that has the greatest impact on consumer inspections.

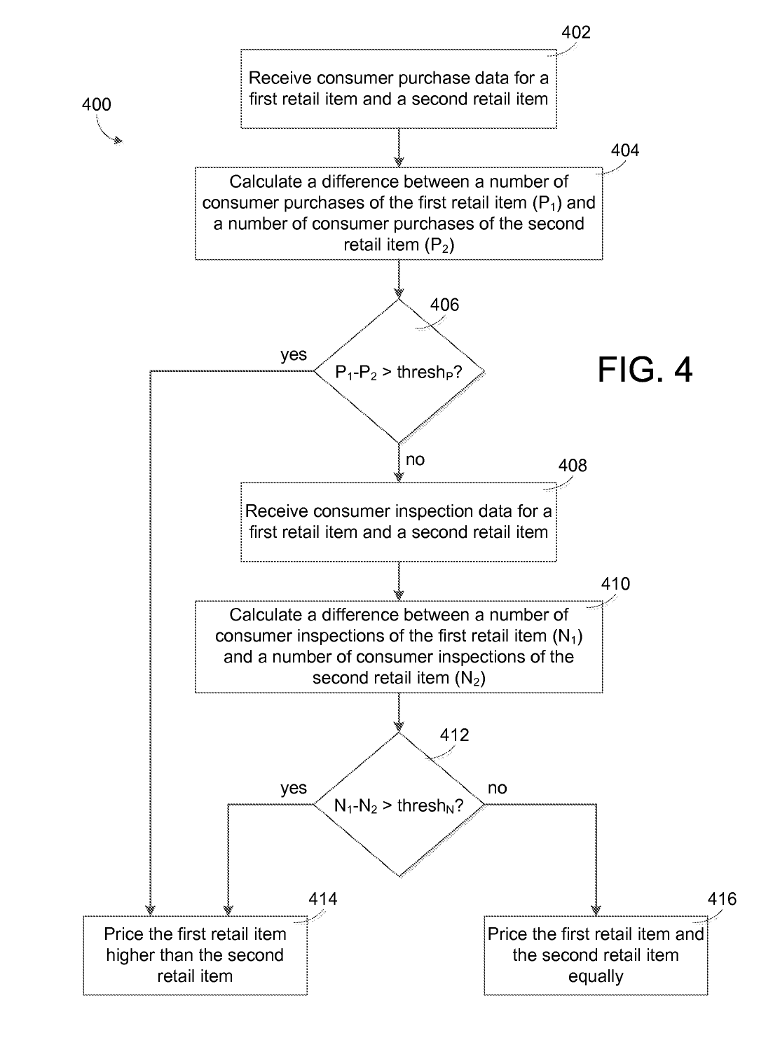

Referring now to FIG. 4, a flowchart of a process 400 for using consumer inspection data to price retail items is shown, according to a described implementation. In some implementations, process 400 may be performed by retail item pricing module 144 as described with reference to FIG. 2.

Process 400 is shown to include receiving consumer purchase data for a first retail item and a second retail item (step 402). The consumer purchase data may include an indication of a number of consumer purchases of the first retail item P₁ and the number of consumer purchases of the second retail item P₂ at the offline location.

Still referring to FIG. 4, process 400 is shown to include calculating a difference between the number of consumer purchases of the first retail item and the number of consumer purchases of the second retail item (step 404) and determining whether the difference exceeds a threshold number of purchases (step 406). The difference between the number of consumer purchases of the first retail item and the second retail item calculated in step 404 may be expressed as P₁−P₂. Determining whether the difference exceeds a threshold number of purchases in step 406 may include comparing the quantity P₁−P₂ with the threshold number of purchases thresh_{P}. If the difference exceeds the threshold number of purchases (i.e., if P₁−P₂>thresh_{P} is true), process 400 may include pricing the first retail item higher than the second retail item (step 414).

Still referring to FIG. 4, process 400 is shown to include receiving consumer inspection data for a first retail item and a second retail item (step 408). Step 408 may be performed in response to a determination in step 406 that the difference between the number of consumer purchases of the first retail item and the number of consumer purchases does not exceed the threshold number of purchases (i.e., if P₁−P₂>thresh_{P} is false). The consumer inspection data may indicate a number of consumer inspections of the first retail item N₁ and the number of consumer inspections of the second retail item N₂ at the offline location.

Still referring to FIG. 4, process 400 is shown to include calculating a difference between the number of consumer inspections of the first retail item and the number of consumer inspections of the second retail item (step 410) and determining whether the difference exceeds a threshold number of inspections (step 412). The difference between the number of consumer inspections of the first retail item and the second retail item calculated in step 410 may be expressed as N₁−N₂. Determining whether the difference exceeds a threshold number of consumer inspections in step 412 may include comparing the quantity N₁−N₂ with the threshold number of inspections thresh_{N}.

If the difference calculated in step 410 exceeds the threshold number of inspections (i.e., if N₁−N₂>thresh_{N} is true in step 412), process 400 may include pricing the first retail item higher than the second retail item (step 414). Step 414 may be performed in response to a determination that the number of consumer inspections of the first retail item significantly exceeds the number of consumer inspections of the second retail item (e.g., N₁−N₂>thresh_{N} is true), notwithstanding the first retail item and the second retail item having a similar number of consumer purchases (e.g., P₁−P₂>thresh_{P} is false).

If the difference calculated in step 410 does not exceed the threshold number of inspections (i.e., if N₁−N₂>thresh_{N} is false in step 412), process 400 may include pricing the first retail item and the second retail item equally (step 416). Step 414 may be performed in response to a determination that the number of consumer inspections of the first retail item is not significantly more than the number of consumer inspections of the second retail item (e.g., N₁−N₂>thresh_{N} is false) and that the first retail item and the second retail item have a similar number of consumer purchases (e.g., P₁−P₂>thresh_{P} is false).

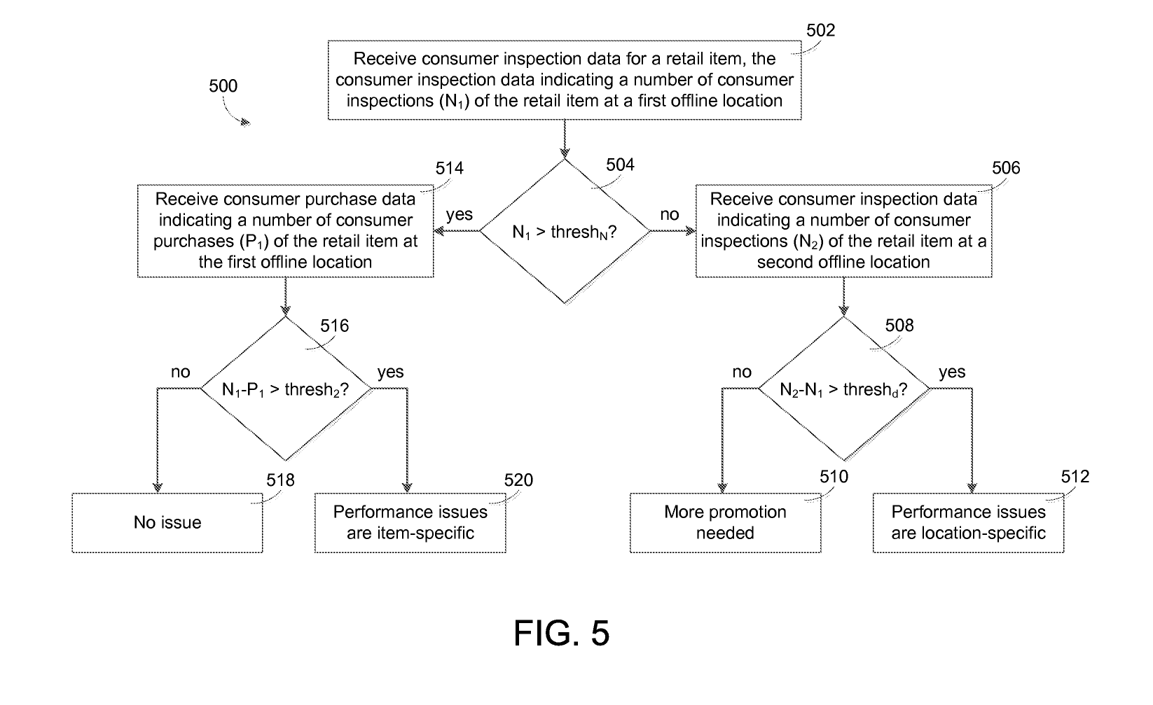

Referring now to FIG. 5, a flowchart of a process 500 for diagnosing sales performance issues with a retail item is shown, according to a described implementation. In some implementations, process 500 may be performed by retail item diagnostic module 146 and/or offline location diagnostic module 148, as described with reference to FIG. 2. Process 500 is shown to include receiving consumer inspection data for a retail item (step 502). The consumer inspection data may indicate a number of consumer inspections N₁ of the retail item at a first offline location.

Still referring to FIG. 5, process 500 is shown to include comparing the number of consumer inspections N₁ of the retail item at the first offline location with a threshold number of consumer inspections thresh_{N} (step 504). If the number of consumer inspections N₁ does not exceed the threshold number of inspections thresh_{N} (i.e., if N₁>thresh_{N} is false), an insufficient number of consumers may be inspecting the retail item at the first offline location. An low number of consumer inspections may be attributable to one or more of a plurality of different factors. For example, an low number of consumer inspections may be attributable to insufficient promotion of the retail item (e.g., insufficient online content promoting the retail item, a poor display location of the retail item in a physical store, etc.) or location-specific issues (e.g., a store location with relatively few customers, unmotivated sales personnel, etc.). To distinguish between these possibilities, additional information may be collected.

Still referring to FIG. 5, process 500 is shown to include receiving consumer inspection data indicating a number of consumer inspections N₂ of the retail item at a second offline location (step 506) and comparing a difference between the number of consumer inspections of the retail item at the first offline location and the number of consumer inspections of the retail item at the second offline location (i.e., N₂−N₁) with a threshold difference thresh_{d} (step 508). Step 506 may be performed in response to a determination in step 504 that the number of consumer inspections N₁ of the retail item at the first offline location does not exceed the threshold number of inspections thresh_{N} (i.e., if N₁>thresh_{N} is false in step 504).

Step 508 may include comparing the quantity N₂−N₁ with the threshold difference thresh_{d}. If the number of consumer inspections of the retail item at the second offline location exceeds the number of consumer inspections of the retail item at the first offline location by an amount exceeding the threshold difference (i.e., if N₂−N₁>thresh_{d} is true), process 500 may include determining that the performance issues are location-specific (step 512). However, if the number of consumer inspections of the retail item at the second offline location does not exceed the number of consumer inspections of the retail item at the first offline location by an amount exceeding the threshold difference (i.e., if N₂−N₁>thresh_{d} is false), process 500 may include determining that more promotion of the retail item is needed (step 510).

Still referring to FIG. 5, process 500 is shown to include receiving consumer purchase data indicating a number of consumer purchases P₁ of the retail item at a first offline location (step 514) and comparing a difference between the number of consumer inspections of the retail item at the first offline location and the number of consumer purchases of the retail item at the first offline location (i.e., N₁−P₁) with a threshold difference thresh₂ (step 516). Step 514 may be performed in response to a determination in step 504 that the number of consumer inspections N₁ of the retail item at the first offline location exceeds the threshold number of inspections thresh_{N} (i.e., if N₁>thresh_{N} is true in step 504). If the number of consumer inspections N₁ exceeds the threshold number of inspections thresh_{N}, a sufficient number of consumers may be inspecting the retail item. However, if the number of consumer inspections N₁ is significantly higher than the number of consumer purchases P₁, consumers may be deterred from purchasing the retail item for other reasons (e.g., pricing, fitting, a poor economy, etc.).

Step 516 may include comparing the quantity N₁−P₁ with the threshold difference thresh₂. If the number of consumer inspections of the retail item at the first offline location exceeds the number of consumer purchases of the retail item at the first offline location by an amount exceeding the threshold difference (i.e., if N₁−P₁>thresh₂ is true), process 500 may include determining that the performance issues are item-specific (step 520). However, if the number of consumer inspections of the retail item at the first offline location does not exceed the number of consumer purchases of the retail item at the first offline location by an amount exceeding the threshold difference (i.e., if N₁−P₁>thresh₂ is false), process 500 may include determining that there is no performance-related issue with the retail item (step 518).

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non volatile memory, media and memory devices, including by way of example semiconductor memory devices (e.g., EPROM, EEPROM, and flash memory devices; magnetic disks, e.g., internal hard disks or removable disks; magneto-optical disks; and CD ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front end component (e.g., a client computer) having a graphical user interface or a web browser through which a user may interact with an implementation of the subject matter described in this disclosure, or any combination of one or more such back end, middleware, or front end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The construction and arrangement of the systems and methods as shown in the various illustrated implementations are examples only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions and arrangement of the exemplary implementations without departing from the scope of the present disclosure.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium.

Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computer-implemented method for measuring an offline impact of online content, the method comprising:
delivering, from a computing system to one or more user devices, online content associated with a retail item;
receiving, at the computing system, consumer inspection data for the retail item, the consumer inspection data comprising an indication of a number of consumer inspections of the retail item at an offline location;
using the consumer inspection data to generate, by the computing system, an inspection-related metric for the online content, wherein the inspection-related metric is a function of the number of consumer inspections of the retail item at the offline location; and
exposing the inspection-related metric to a content provider associated with the online content.

2. The method of claim 1, wherein the consumer inspection data measure a consumer interest in the retail item at the offline location not necessarily reflected in consumer purchase data for the retail item.

3. The method of claim 1, further comprising:
associating the online content with the inspection-related metric for the retail item;
using the inspection-related metric to determine a pricing value for the online content; and
determining a target bid for the online content based on the pricing value for the online content.

4. The method of claim 1, further comprising:
using the inspection-related metric to determine a pricing value for the online content; and
in a programmatic auction, submitting a bid on an opportunity to present the online content, wherein the bid is a function of the pricing value for the online content.

5. The method of claim 1, wherein the inspection-related metric is an effective cost of the consumer inspections of the retail item at the offline location, the method further comprising:
determining a ranking for the online content based on the effective cost of the consumer inspections.

6. The method of claim 1, further comprising:
receiving consumer purchase data for the retail item, the consumer purchase data comprising an indication of a number of consumer purchases of the retail item at the offline location;
determining a difference between the number of consumer inspections of the retail item at the offline location and the number of consumer purchases of the retail item at the offline location; and
using the difference between the number of consumer inspections and the number of consumer purchases to generate a performance metric for the retail item.

7. The method of claim 1, wherein the online content associated with the retail item comprises at least one of:
advertising content associated with the retail item;
a website related to the retail item; or
an online review of the retail item.

8. The method of claim 1, wherein the retail item is at least one of a consumer product or a consumer service available for purchase at the offline location

9. The method of claim 1, wherein a consumer inspection of the retail item at the offline location comprises at least one of:
trying on an item of apparel at the offline location, wherein the item of apparel is the retail item;
viewing the retail item in a physical store at the offline location; or
using the retail item.

10. A computer-implemented method for using consumer inspection data to price retail items, the method comprising:
receiving, at a computing system, consumer inspection data for a first retail item and a second retail item, the consumer inspection data comprising an indication of a number of consumer inspections of the first retail item at an offline location and an indication of a number of consumer inspections of the second retail item at the offline location;
using the consumer inspection data to generate, by the computing system, a first inspection-related metric for the first retail item and a second inspection-related metric for the second retail item, wherein the first inspection-related metric is a function of the number of consumer inspections of the first retail item at the offline location and the second inspection-related metric is a function of the number of consumer inspections of the second retail item at the offline location;
calculating, by the computing system, a difference between the first inspection-related metric and the second inspection-related metric; and
in response to the difference between the first inspection-related metric and the second inspection-related metric exceeding a threshold value, determining, by the computing system, a pricing value for the first retail item and the second retail item such that the pricing value for the first retail item exceeds the pricing value for the second retail item.

11. The method of claim 10, wherein the consumer inspection data measure a consumer interest in the first retail item and the second retail item at the offline location not necessarily reflected in consumer purchase data for the retail items.

12. The method of claim 10, further comprising:
in response to the difference between the first inspection-related metric and the second-related metric not exceeding the threshold value, determining, by the computing system, a pricing value for the first retail item and the second retail item such that the pricing value for the first retail item is equal to the pricing value for the second retail item.

13. The method of claim 10, further comprising:
prior to receiving the consumer inspection data, receiving consumer purchase data for the first retail item and the second retail item, the consumer purchase data comprising an indication of a number of consumer purchases of the first retail item at the offline location and an indication of a number of consumer purchases of the second retail item at the offline location; and
determining whether a difference between the number of consumer purchases of the first retail item and the number of consumer purchases of the second retail item exceeds a threshold number of purchases;
wherein receiving the consumer inspection data for the first retail item and the second retail item is performed in response to a determination that the difference between the number of consumer purchases of the first retail item and the number of consumer purchases of the second retail item does not exceed the threshold number of purchases.

14. The method of claim 13, further comprising:
in response to a determination that the number of consumer purchases of the first retail item exceeds the number of consumer purchases of the second retail item by at least the threshold number of purchases, determining, by the computing system, a pricing value for the first retail item and the second retail item such that the pricing value for the first retail item exceeds the pricing value for the second retail item.

15. A computer-implemented method for diagnosing sales performance issues with a retail item, the method comprising:
receiving, at a computing system, consumer inspection data for a retail item, the consumer inspection data comprising an indication of a number of consumer inspections of the retail item at a first offline location;
comparing the number of consumer inspections of the retail item at the first offline location with a threshold number of inspections;
in response to a determination that the number of consumer inspections of the retail item at the first offline location exceeds the threshold number of inspections, attributing a poor sales performance to an item-specific issue; and
in response to a determination that the number of consumer inspections of the retail item at the first offline location does not exceed the threshold number of inspections, attributing the poor sales performance to at least one of a promotional issue or a location-specific issue.

16. The method of claim 15, further comprising, in response to a determination that the number of consumer inspections of the retail item at the first offline location does not exceed the threshold number of inspections:
receiving consumer inspection data indicating a number of consumer inspections of the retail item at a second offline location;
comparing a difference between the number of consumer inspections of the retail item at the second offline location and the number of consumer inspections of the retail item at the first offline location with a threshold difference value; and
attributing the poor sales performance to either a promotional issue or a location specific issue based on a result of the comparison.

17. The method of claim 16, further comprising:
attributing the poor sales performance to a promotional issue in response to a determination that the difference between the number of consumer inspections of the retail item at the second offline location and the number of consumer inspections of the retail item at the first offline location does not exceed the threshold difference value.

18. The method of claim 16, further comprising:
attributing the poor sales performance to a location-specific issue in response to a determination that the difference between the number of consumer inspections of the retail item at the second offline location and the number of consumer inspections of the retail item at the first offline location exceeds the threshold difference value.

19. The method of claim 15, further comprising, in response to a determination that the number of consumer inspections of the retail item at the first offline location exceeds the threshold number of inspections:
receiving consumer purchase data indicating a number of consumer purchases of the retail item at the first offline location;
comparing a difference between the number of consumer inspections of the retail item at the first offline location and the number of consumer purchases of the retail item at the first offline location with a threshold difference value; and
determining whether an item-specific issue is causing a poor sales performance based on a result of the comparison.

20. The method of claim 19, further comprising:
attributing the poor sales performance to an item-specific issue in response to a determination that the number of consumer inspections of the retail item at the first offline location and the number of consumer purchases of the retail item at the first offline location exceeds the threshold difference value.
